(19) United States
(12) Patent Application Publication
(10) Pub. No.: US 2006/0021424 A1
(43) Pub. Date: Feb. 2, 2006

(54) Automotive air-conditioner

(75) Inventors: Tsugutaka Ishikawa, Sano-shi (JP); Yasuyuki Iino, Ashikaga-shi (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/179,503

(22) Filed: Jul. 13, 2005

(30) Foreign Application Priority Data
Jul. 27, 2004 (JP) 2004-219005

(51) Int. Cl. G01P 5/00

(52) U.S. Cl. 73/118.2

(57) ABSTRACT

An automotive air-conditioner includes a heating heat exchanger, a bypass passage, a hot air passage, an air mixing door, an air mixing chamber, a front outlet passage diverging from the air mixing chamber toward a front side of a passenger compartment, a rear outlet passage diverging from downstream of the heating heat exchanger in the hot air passage toward a rear side of the passenger compartment, a door configured to open and close the rear outlet passages and an inlet of the rear outlet passage configured to avoid overlap with an inlet of the hot air passage in an airflow direction perpendicular to a face of the heating heat exchanger, the inlet of the rear outlet passage is provided across the inlet of the hot air passage from the air mixing chamber in the airflow direction.

### CROSS REFERENCE TO RELATED APPLICATIONS AND INCORPORATED BY REFERENCE

This application is based upon and claims the benefit of priority from the prior Japanese Patent Application No. 2004-219005 filed on Jul. 27, 2004; the entire contents of which are incorporated herein by reference.

### BACKGROUND OF THE INVENTION

1. Field of the Invention

The present invention relates to automotive air-conditioners.

2. Description of the Related Art

An automotive air-conditioner includes a heater core, a hot air passage for conducting hot air heated in the heater core, a bypass passage for conducting cool air to bypass the heater core, an air mixing controller for adjusting the ratio of airflow from the hot air passage and the bypass passage, an air mixing chamber located at the confluence of airflow for mixing hot air and cool air, and a plurality of front outlet passages diverging from the air mixing chamber toward front seats of a passenger compartment.

In Japanese Unexamined Patent Application Publication No. H10-114209, an example is disclosed in which a rear outlet passage diverges from a front outlet passage toward rear seats of a passenger compartment. In this case, the operation of discharging heated air to the rear sears is improved.

### SUMMARY OF THE INVENTION

Those conventional cases, the air heated by a heater core flows through a tortuous flow path from the heater core, through the hot air passage, the air mixing chamber, the front outlet passage and the rear outlet passage to the rear seats. Because of the tortuous flow path there is a large resistance in discharging the flow of hot air to the rear seats. There have been problems such as the difficulty of maintaining a desired airflow volume, or loud airflow noise.

The present invention has been developed in view of the above problems, and provides an automotive air-conditioner which can discharge hot air from a heater core to the rear seat area in a passenger compartment and avoid the high a low airflow resistance in the conventional devices.

A first aspect of the present invention provides an automotive air-conditioner comprising a heating heat exchanger; a bypass passage through which cool air bypasses the heating heat exchanger; a hot air passage through which hot air passing through the heating heat exchanger flows, the hot air passage including a downstream portion of the heating heat exchanger curved toward the bypass passage; an air mixing door configured to control airflow volume of cool air flowing through the bypass passage and hot air flowing through the hot air passage; an air mixing chamber located at a confluence of the bypass passage and the hot air passage and configured to mix the hot air and the cool air; at least one front outlet passage diverging from the air mixing chamber toward a front side of a passenger compartment; a rear outlet passage diverging from downstream of the heating heat exchanger in the hot air passage toward a rear side of the passenger compartment; a door configured to open and close the rear outlet passages; and, an inlet of the rear outlet passage configured to avoid overlap with an inlet of the hot air passage in an airflow direction perpendicular to a face of the heating heat exchanger, the inlet of the rear outlet passage being provided across the inlet of the hot air passage from the air mixing chamber in the airflow direction.

A second aspect of the present invention provides an automotive air-conditioner comprising: a heating heat exchanger; a bypass passage through which cool air bypasses the heating heat exchanger; a hot air passage through which hot air passing through the heating heat exchanger flows, the hot air passage including a downstream portion of the heating heat exchanger curved toward the bypass passage; an air mixing door configured to control airflow volume of cool air flowing through the bypass passage and hot air flowing through the hot air passage; an air mixing chamber located at a confluence of the bypass passage and the hot air passage and configured to mix the hot air and the cool air; at least one front outlet passage diverging from the air mixing chamber toward a front side of a passenger compartment; at least one rear outlet passage diverging from the air mixing chamber toward a rear side of the passenger compartment; a communication path diverging from downstream of the heating heat exchanger in the hot air passage to at least one of the at least one rear outlet passage, the communication path configured to avoid overlap with an inlet of the hot air passage in an airflow direction perpendicular to a face of the heating heat exchanger, the communication path provided across the inlet of the hot air passage from the air mixing chamber in the airflow direction; and, a door configured to open and close the communication path.

### BRIEF DESCRIPTION OF THE SEVERAL VIEWS OF THE DRAWINGS

FIG. 1 is a side view of an automotive air-conditioner in the first embodiment of the present invention;

FIG. 2 is a plan view of an air-conditioning unit in the automotive air-conditioner;

FIG. 3 is an elevation view of a part of the air-conditioning unit in the automotive air-conditioner;

FIG. 4 is a cross-sectional view of the air-conditioning unit in the automotive air-conditioner taken along line SA-SA in FIG. 3;

FIG. 5A is a cross-sectional view of the air-conditioning unit in the automotive air-conditioner taken along line SB-SB in FIG. 3; and FIG. 5B is a projected plane view along the direction Y in FIG. 5A;

FIG. 6 is a cross-sectional view of the air-conditioning unit in the automotive air-conditioner taken along line SC-SC in FIG. 3;

FIG. 7 is a perspective view illustrating an arranging orientation of a heater core;

FIGS. 8A to 8C are schematic diagrams illustrating the flow of conditioned air in a vent mode in the automotive air-conditioner; FIG. 8A is a cross-sectional view taken along line SA-SA in FIG. 3; FIG. 8B is a cross-sectional view taken along line SB-SB in FIG. 3; and FIG. 8C is a cross-sectional view taken along line SC-SC in FIG. 3;

FIGS. 9A to 9C are schematic diagrams illustrating the flow of conditioned air in a bi-level mode in the automotive air-conditioner; FIG. 9A is a cross-sectional view taken along line SA-SA in FIG. 3; FIG. 9B is a cross-sectional view taken along line SB-SB in FIG. 3; and FIG. 9C is a cross-sectional view taken along line SC-SC in FIG. 3;

FIGS. 10A to 10C are schematic diagrams illustrating the flow of conditioned air in a foot mode in the automotive air-conditioner; FIG. 10A is a cross-sectional view taken along line SA-SA in FIG. 3; FIG. 10B is a cross-sectional view taken along line SB-SB in FIG. 3; and FIG. 10C is a cross-sectional view taken along line SC-SC in FIG. 3;

FIGS. 11A to 11C are schematic diagrams illustrating the flow of conditioned air in a defroster-foot mode in the automotive air-conditioner; FIG. 11A is a cross-sectional view taken along line SA-SA in FIG. 3; FIG. 11B is a cross-sectional view taken along line SB-SB in FIG. 3; and FIG. 11C is a cross-sectional view taken along line SC-SC in FIG. 3;

FIGS. 12A to 12C are schematic diagrams illustrating the flow of conditioned air in a defroster mode in the automotive air-conditioner; FIG. 12A is a cross-sectional view taken along line SA-SA in FIG. 3; FIG. 12B is a cross-sectional view taken along line SB-SB in FIG. 3; and FIG. 12C is a cross-sectional view taken along line SC-SC in FIG. 3.

FIG. 13 is a side view of an automotive air-conditioner in the second embodiment of the present invention;

FIG. 14 is a plan view of an air-conditioning unit in the automotive air-conditioner;

FIG. 15 is an elevation view of a part of the air-conditioning unit in the automotive air-conditioner;

FIG. 16 is a cross-sectional view of the air-conditioning unit in the automotive air-conditioner taken along line SA-SA in FIG. 15;

FIG. 17A is a cross-sectional view of the air-conditioning unit in the automotive air-conditioner taken along line SB-SB in FIG. 15; and FIG. 17B is a projected plane view along the direction Y in FIG. 17A;

FIG. 18 is a cross-sectional view of the air-conditioning unit in the automotive air-conditioner taken along line SC-SC in FIG. 15;

FIG. 19 is a partially exploded perspective view of the air-conditioning unit in the automotive air-conditioner;

FIGS. 20A to 20C are schematic diagrams illustrating the flow of conditioned air in a vent mode in the automotive air-conditioner; FIG. 20A is a cross-sectional view taken along line SA-SA in FIG. 15; FIG. 20B is a cross-sectional view taken along line SB-SB in FIG. 15; and FIG. 20C is a cross-sectional view taken along line SC-SC in FIG. 15;

FIGS. 21A to 21C are schematic diagrams illustrating the flow of conditioned air in a bi-level mode in the automotive air-conditioner; FIG. 21A is a cross-sectional view taken along line SA-SA in FIG. 15; FIG. 21B is a cross-sectional view taken along line SB-SB in FIG. 15; and FIG. 21C is a cross-sectional view taken along line SC-SC in FIG. 15;

FIGS. 22A to 22C are schematic diagrams illustrating the flow of conditioned air in a foot mode in the automotive air-conditioner; FIG. 22A is a cross-sectional view taken along line SA-SA in FIG. 15; FIG. 22B is a cross-sectional view taken along line SB-SB in FIG. 15; and FIG. 22C is a cross-sectional view taken along line SC-SC in FIG. 15;

FIGS. 23A to 23C are schematic diagrams illustrating the flow of conditioned air in a defroster-foot mode in the automotive air-conditioner; FIG. 23A is a cross-sectional view taken along line SA-SA in FIG. 15; FIG. 23B is a cross-sectional view taken along line SB-SB in FIG. 15; and FIG. 23C is a cross-sectional view taken along line SC-SC in FIG. 15; and

FIGS. 24A to 24C are schematic diagrams illustrating the flow of conditioned air in a defroster mode in the automotive air-conditioner; FIG. 24A is a cross-sectional view taken along line SA-SA in FIG. 15; FIG. 24B is a cross-sectional view taken along line SB-SB in FIG. 15; and FIG. 24C is a cross-sectional view taken along line SC-SC in FIG. 15.

### DETAILED DESCRIPTION OF THE INVENTION

Embodiments of the present invention will be described below with reference to the drawings.

### First Embodiment

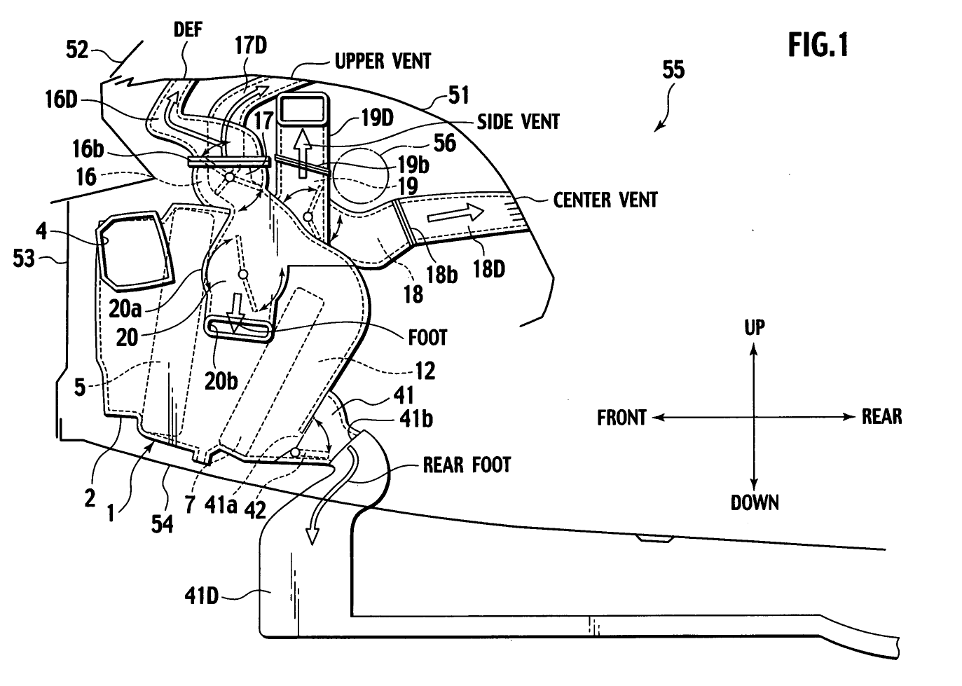

In FIG. 1, reference numeral 1 denotes an air-conditioning unit; an instrument panels indicated at 51; a windshield is denoted by 52; a dash panel is shown at 53; a floor tunnel is indicated at 54; and a passenger compartment is denoted by 55. An automotive air-conditioner includes an intake box for selectively receiving air from inside and outside of the passenger compartment, a blower for moving air downstream from the intake box, and an air-conditioning unit 1 for conditioning the air flowing from the blower and discharging the air into the passenger compartment 55.

The air-conditioning unit 1 is located internally of the instrument panel 51 and disposed at the center of the vehicle. The air-conditioning unit 1 includes an air-conditioning case 2 in which an air passage is formed. The air-conditioning case 2 has an inlet 4 provided at an upstream end of the air passage and outlets 16b to 20b and 41b provided at downstream ends of the air passage. Outlet ducts 16D to 20D and 41D are connected to the respective outlets 16b to 20b and 41b. Air conditioned in the air-conditioning unit 1 is discharged through the outlet ducts 16D to 20D and 41D, connected to the outlets 16b to 20b and 41b, into the passenger compartment 55.

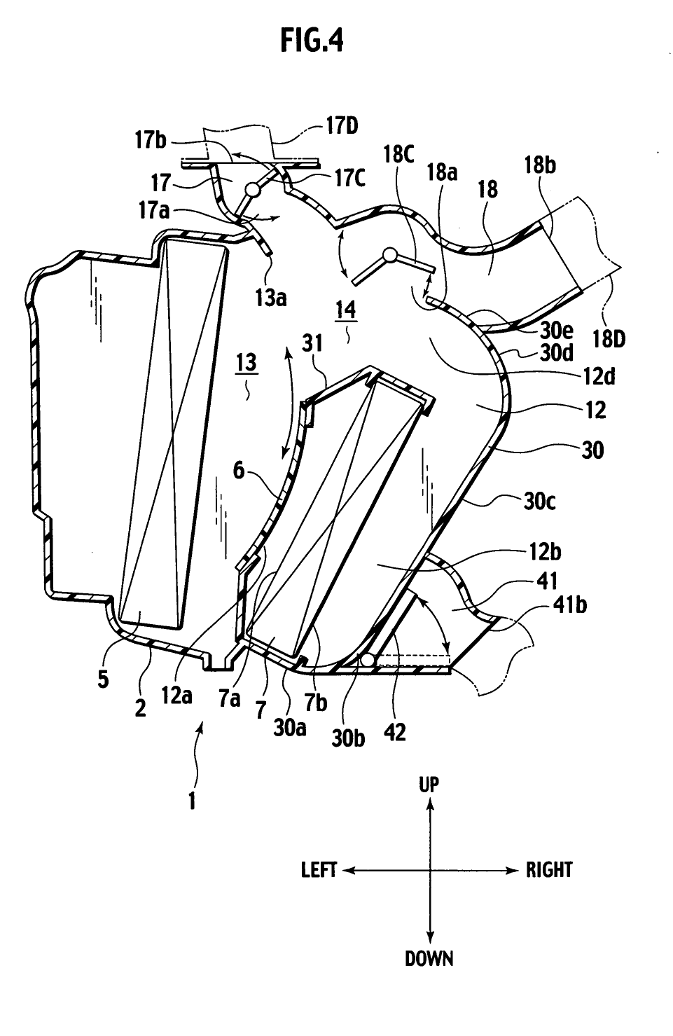

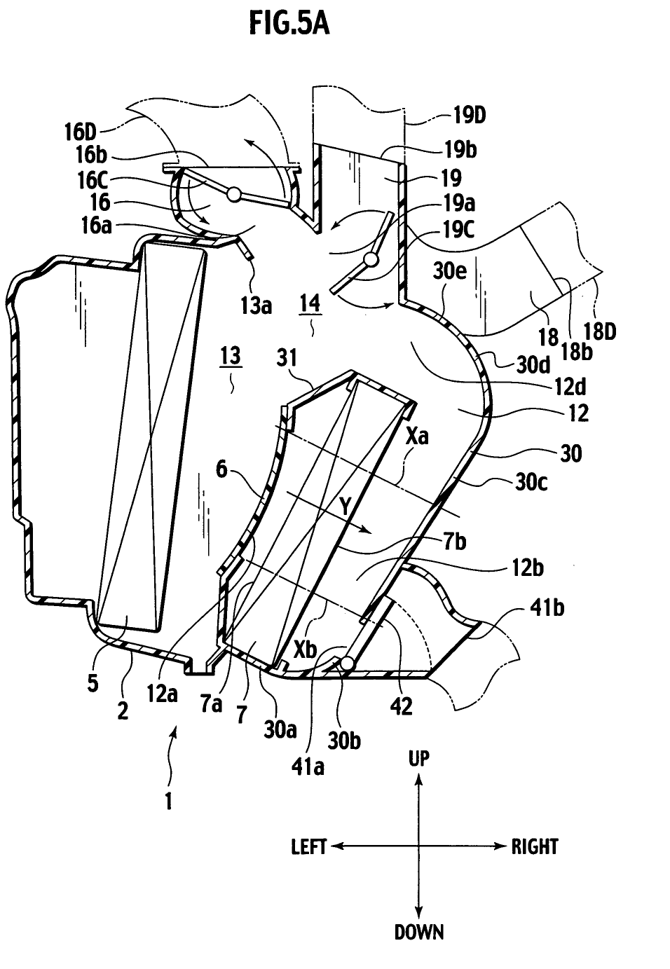

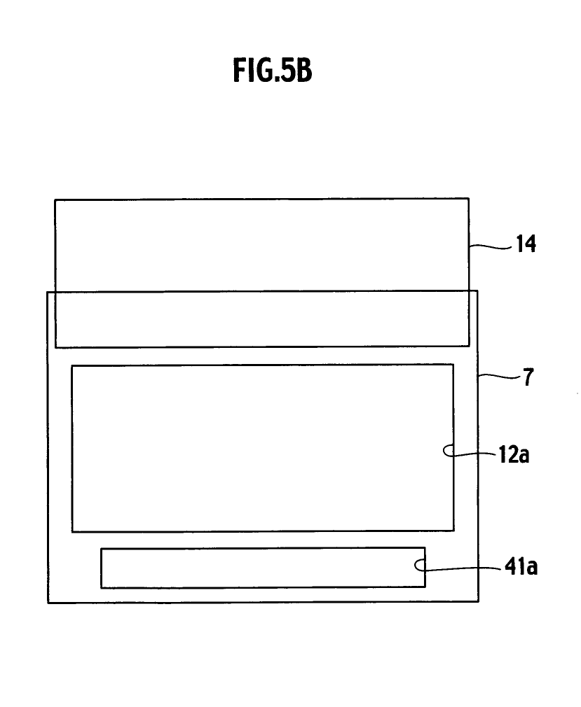

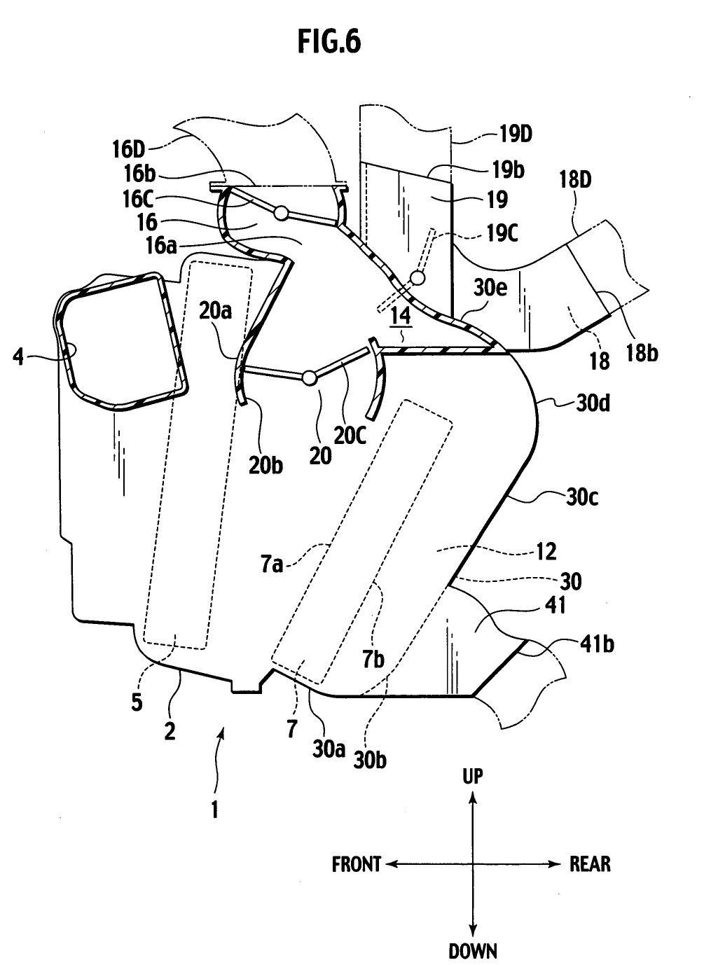

The structure of the air-conditioning unit 1 will be described in more detail below with reference to FIGS. 4 to 6.

As shown in FIG. 4, an evaporator 5 is provided as a cooling heat exchanger, an air mixing door 6 is provided as a temperature adjuster, and a heater core 7 is provided as a heating heat exchanger, each of which are arranged in the air-conditioning case 2.

The evaporator 5 circulates a low-temperature low-pressure refrigerant inside of the evaporator 5 so that the refrigerant provided absorbs heat from the air to cool and dehumidifies the air. The evaporator 5 is positioned almost upright at a slightly backward tilt with respect to the longitudinal direction of the vehicle to allow air to pass therethrough from the front to the rear of the evaporator 5.

The heater core 7 circulates hot water as heating medium inside of the heater core 7 to heat the air. The hot water is heated by exhaust heat from an engine as the heat source. The heater core 7 is positioned at a greater backward tilt with respect to the longitudinal direction of the vehicle than the evaporator 5. The heater core 7 has a front face 7a for receiving a cool air flow and a back face 7b, out which hot air flows. The faces 7a, 7b of the heater core 7 are of smaller height and smaller size than the faces of the evaporator 5. The heater core 7 is opposed to the evaporator 5 in a position rearward of the evaporator 5 with a space therebetween so as to avoid interference with an upper side of the evaporator 5.

A downstream portion of the evaporator 5 branches into a hot air passage 12 and a bypass passage 13. The hot air passage 12 allows cooled air passing through the evaporator 5 to pass through the heater core 7 and circulates hot air. The bypass passage 13 allows cooled air passing through the evaporator 5 to bypass the heater core 7. An inlet 12a of the hot air passage 12 and an inlet 13a of the bypass passage 13 are vertically aligned.

The air mixing door 6 functions as a temperature adjuster and is provided at the inlets 12a, 13a. The air mixing door 6 is used for controlling the ratio of the airflow volumes distributed to the bypass passage 13 and the hot air passage 12. The air mixing door 6 of the first embodiment is a sliding door which is formed as a circular plate with a convexity extending in the downstream direction. The ratio of airflow volumes distributed to the passages 12, 13 is controlled by sliding the air mixing door 6 over the inlets 12a, 13a.

The bypass passage 13 is formed to extend linearly toward vent outlet passages 18, 19 through an air mixing chamber 14. The hot air passage 12 is formed as curved passage extending toward the bypass passage 13 above by a hot air guide wall 30. The hot air guide wall 30 is disposed substantially parallel and close to and opposite the heater core 7. The hot air guide wall 30 is formed in a U-shaped configuration, including a bottom portion 30a, an opposite portion 30c and an upper portion 30e. The bottom portion 30a is provided along the bottom portion of the heater core 7. The opposite portion 30c is provided substantially parallel to the rear face 7b of the heater core 7. The upper portion 30e is provided along the upper portion of the heater core 7. The bottom portion 30a and the opposite portion 30c are connected through a circular curving portion 30b, and the opposite portion 30c and the upper portion 30e are connected through a circular curving portion 30d.

The downstream confluence of the bypass passage 13 and the hot air passage 12 constitutes the air mixing chamber 14 for mixing cooled air and heated air. A plurality of front outlet passages 16 to 20 diverge from the air mixing chamber 14. The front outlet passages 16 to 20 include a pair of defroster outlet passages 16, an upper vent outlet passage 17, vent outlet passages 18 and 19, and a pair of foot outlet passages 20.

The outlet passages 16 to 20 will be described in more detail below.

The defroster outlet passages 16 diverge upward from the air mixing chamber 14. Defroster doors 16C are provided at the inlets 16a of the defroster outlet passages 16. The defroster doors 16C allow the defroster outlet passages 16 to be opened and closed. The outlet ducts 16D for discharging conditioned air toward the windshield are connected to the outlets 16b of the defroster outlet passages 16.

The upper vent outlet passage 17 diverges upward from the air mixing chamber 14. An upper vent door 17C is provided at an inlet 17a of the upper vent outlet passage 17. The upper vent door 17C allows the upper vent outlet passage 17 to be opened and closed. The outlet duct 17D for discharging air upwardly for the front seat occupants is connected to the outlet 17b of the upper vent outlet passage 17.

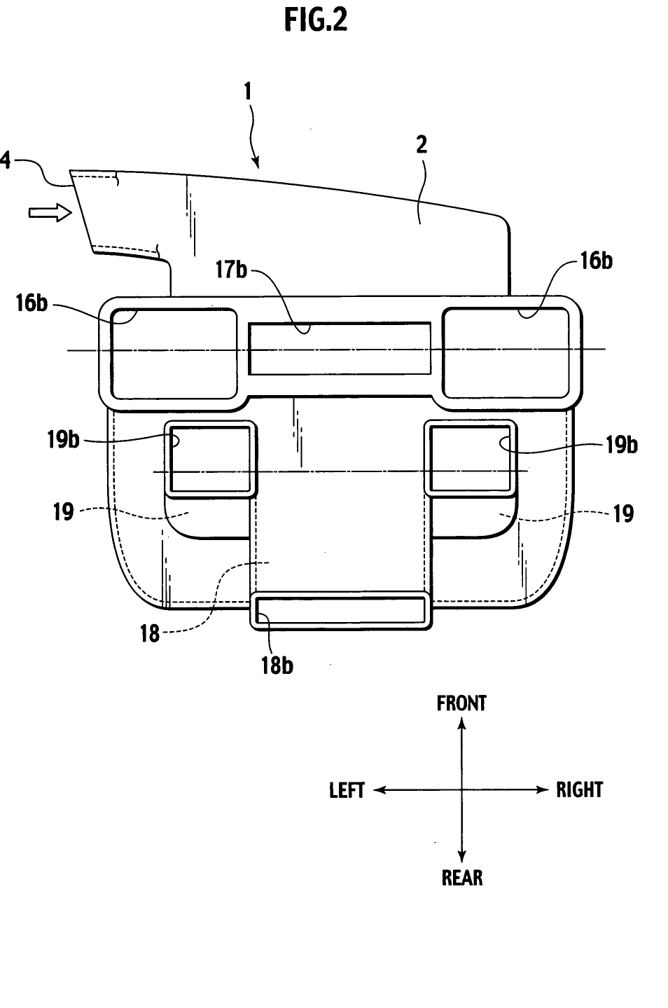

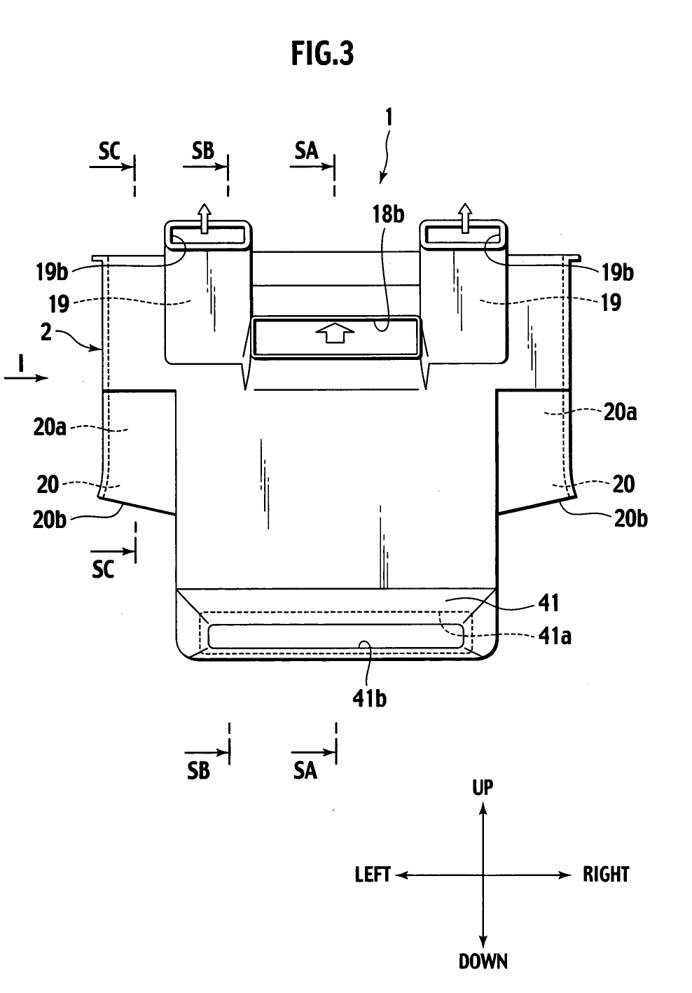

The outlets 16b of the defroster outlet passages 16 are provided on the right and left sides of the outlet 17b of the upper vent outlet passage 17 (see FIG. 2). The defroster doors 16C and the upper vent door 17C are integrally formed on a rotary shaft for integrated opening and closing operations.

The vent outlet passages 18, 19 are a center vent outlet passage 18 for discharging conditioned air toward the upper bodies of the front seat occupants, and a pair of side vent outlet passages 19 for discharging conditioned air toward the side windows. An inlet 18a of the center vent outlet passage 18 and inlets 19a of the side vent outlet passages 19 are laterally aligned. Doors 18C, 19C are respectively provided at the inlets 18a, 19a. The doors 18C, 19C allow the outlet passages 18, 19 to be opened and closed. The vent doors 18C, 19C share a single rotary shaft for integrated opening and closing operations. The vent doors 18C, 19C are bent to form a V-shaped configuration that is parallel with the respective passages 18, 19 when the passages 18, 19 are fully opened, so as to reduce airflow resistance and to provide improved performance in discharging cool air from the vent outlet passages 18, 19 (discharge performance in cooling).

The outlet duct 18D is situated toward the upper bodies of the front seat occupants and is connected to the outlet 18b of the center vent outlet passage 18. The outlet ducts 19D are situated toward the side windows (not shown) and are connected to the outlets 19b of the side vent outlet passages 19.

The foot outlet passages 20 diverge from the air mixing chamber 14 toward the feet of the front seat occupants. The foot outlet passages 20 include cylindrical inlets 20a provided on the right and left sides of the air mixing chamber 14. Foot doors 20C are provided at the inlets 20a of the foot outlet passages 20. Each of the foot doors 20C allows the foot outlet passages 20 to be opened and closed.

In the first embodiment, a rear outlet passage 41 is provided in addition to the front outlet passages 16 to 20. The rear outlet passage 41 diverges from the downstream portion of the hot air passage 12, which is lower than the heater core 7. A door 42 is provided at an inlet 41a of the rear outlet passage 41. The door 42 allows the rear outlet passage 41 to be opened and closed. When the door 42 opens the inlet 41a of the rear outlet passage 41, the hot air in the hot air passage 12 directly flows into the rear outlet passage 41 without a long flow path through the air mixing chamber 14.

The inlet 41a of the rear outlet passage 41 is located on or near the circular curving portion 30b of the hot air guide wall 30. As shown in FIGS. 5A and 5B, in a projected plane view along an airflow direction Y perpendicular to the faces 7a, 7b of the heater 7, the inlet 33 is located on a projected plane of the rear face 7b of the heater core 7. The inlet 41a does not overlap with the inlet 12a of the hot air passage 12 in a view along an airflow direction Y. The inlet 41a is provided across the inlet 12a of the hot air passage 12 from the air mixing chamber 14 in the view along the airflow direction Y.

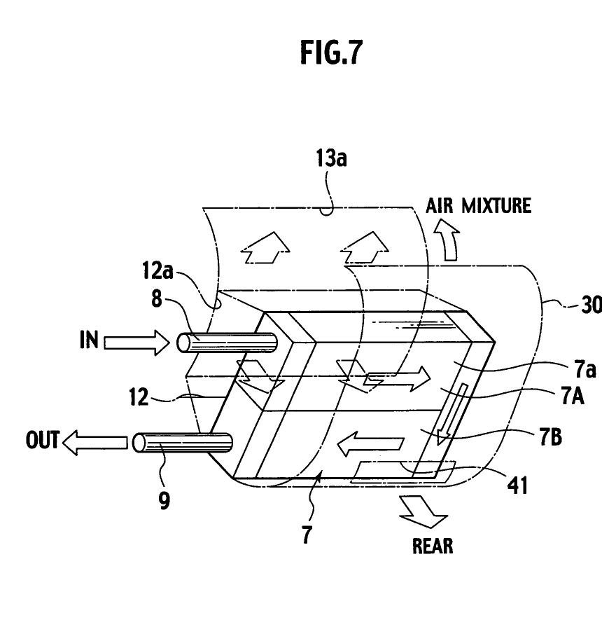

FIG. 7 illustrates an orientation of the heater core 7. More specifically, FIG. 7 illustrates positional relations for arranging a hot water upstream path and a hot water downstream path.

As shown in FIG. 7, the heater core 7 of the first embodiment includes two paths 7A and 7B. The hot water is first introduced to the heater core 7 from a hot water inlet 8 and flows into the upper path 7A, and then turns around to flow into the lower path 7B. The hot water is finally discharged from a hot air outlet 9. That is, in the first embodiment, the path 7A is an upstream path provided near the air mixing chamber 14, and the path 7B is a downstream path provided near the inlet 41a of the rear outlet passage 41.

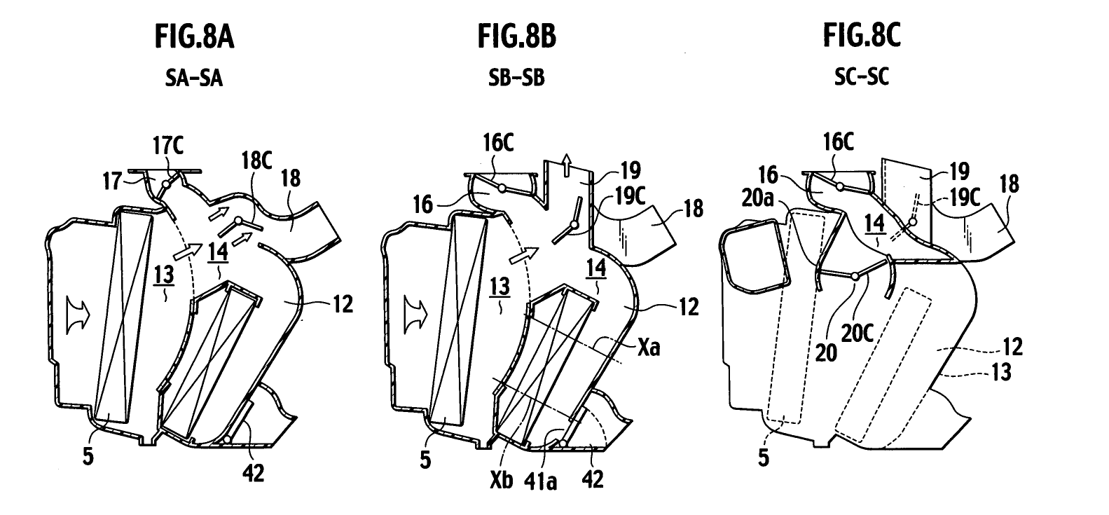

The flow of conditioned air, in principal modes, in the automotive air-conditioner configured as described above will be described with reference to FIGS. 8A to 12C.

Vent Mode (FIGS. 8A to 8C)

First, with reference to FIGS. 8A to 8C, a vent mode will be described. The vent mode is a mode in which conditioned air is discharged from the vent outlet passages 18, 19. Specifically, the opening of the doors 16C to 20C and 42 is adjusted so that the upper vent outlet passage 17 is fully closed and the center vent outlet passage 18 is fully opened as shown in FIG. 8A. The defroster outlet passages 16 are fully closed and the side vent outlet passages 19 are fully opened as shown in FIG. 8B; and, the foot outlet passages 20 is fully closed as shown in FIG. 8C. In the vent mode, the air-conditioning mode is set to a full-cooling mode. That is, the air mixing door 6 totally closes the hot air passage 12 and fully opens the bypass passage 13 so as to only discharge cooled air.

With this, cooled air flowing into the air mixing chamber 14, through the bypass passage 13, is discharged into the passenger compartment 55 through the center vent outlet passage 18 and the side vent outlet passages 19.

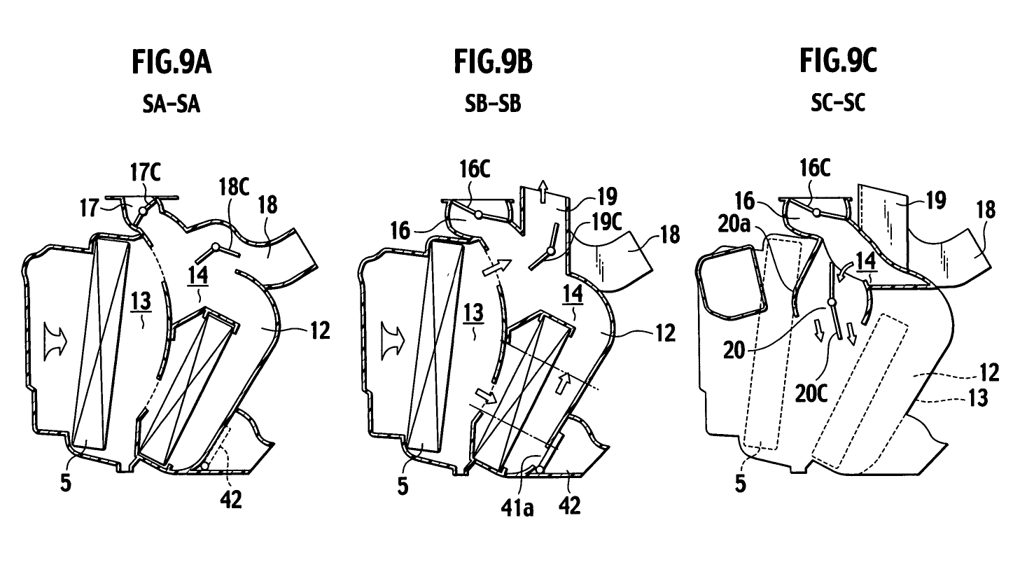

Bi-Level Mode (FIGS. 9A to 9C)

With reference to FIGS. 9A to 9C, a bi-level mode will be described. The bi-level mode is a mode in which conditioned air is discharged from both the vent outlet passages 18, 19 and the foot outlet passages 20. Specifically, the opening of the doors 16C to 20C and 42 is adjusted so that the upper vent outlet passage 17 is totally closed and the center vent outlet passage 18 is fully opened as shown in FIG. 9A. The defroster outlet passages 16 are totally closed and the side vent outlet passages 19 are totally opened as shown in FIG. 9B; and, the foot outlet passages 20 is opened as shown in FIG. 9C. In the bi-level mode, the air-conditioning mode is set to an air-mixing mode. Specifically, the air mixing door 6 opens both the hot air passage 12 and the bypass passage 13 so that cooled air and heated air are mixed in the air mixing chamber 14 so as to be discharged therefrom.

With this arrangement, air mixed in the air mixing chamber 14 and conditioned to a desired temperature is discharged from the air mixing chamber 14 through the center vent outlet passage 18, the side vent outlet passages 19 and the foot outlet passages 20 into the passenger compartment 55.

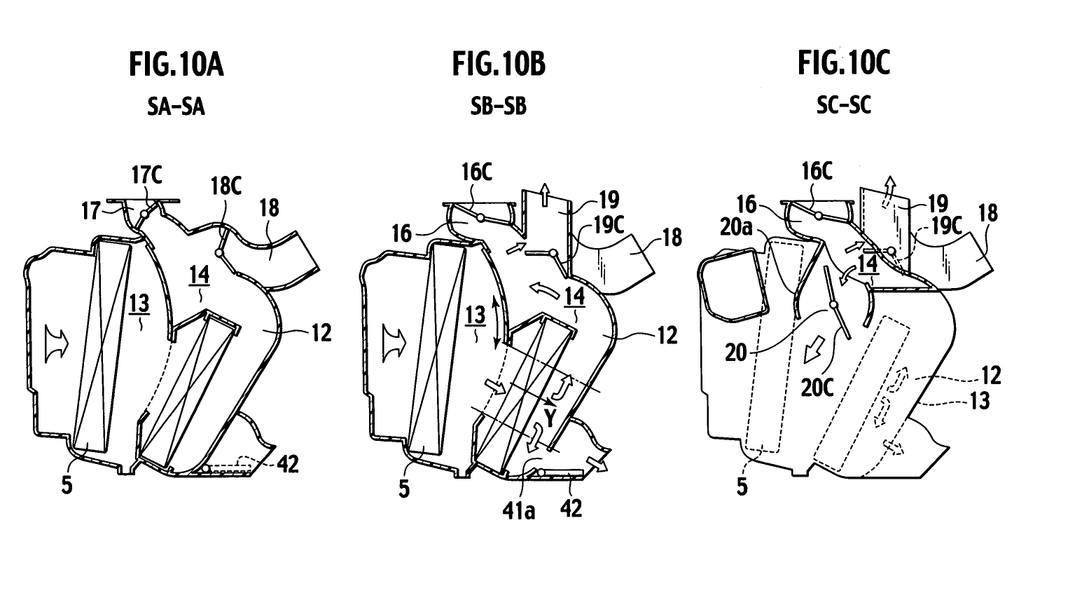

Foot Mode (FIGS. 10A to 10C)

With reference to FIGS. 10A to 10C, a foot mode will be described. IN the foot mode, conditioned air is discharged from the foot outlet passages 20. Specifically, the opening of the doors 16C to 20C and 42 is adjusted so that the upper vent outlet passage 17 is totally closed and the center vent outlet passage 18 is totally closed as shown in FIG. 10A. The defroster outlet passages 16 are totally closed and the side vent outlet passages 19 are opened as shown in FIG. 10B; and, the foot outlet passages 20 is opened as shown in FIG. 10C. Also, the inlet 41a of the rear outlet passage 41 is fully opened. In the foot mode, the air-conditioning mode is set to a full-heating mode. That is, the air mixing door 6 fully opens the hot air passage 12 and fully closes the bypass passage 13 so as to only discharge hot air.

With this arrangement, as shown in FIG. 10B, the heated air from the heater core 7 is guided by the hot air guide wall 30, and divided so as to flow into the air mixing chamber 14 and the rear outlet passage 41. The hot air flowing into the air mixing chamber 14 through the hot air passage 12 (see FIG. 10B) is then discharged through the side vent outlet passages 19 and the foot outlet passages 20 into the passenger compartment 55 as shown in FIG. 10C. On the other hand, the heated air directly flowing into the rear outlet passage 41 is discharged to the rear foot space of the passenger compartment 55.

As described above, the heated air conducts the hot air guide wall 30 and diverges toward the air mixing chamber 14 and the rear outlet passage 41. There may be a concern that most of the heated air from the heater core 7 will unevenly flow into the rear outlet passage 41, as the rear outlet passage inlet 41a is located near the rear face 7b of the heater core 7. However, in the first embodiment, the rear outlet passage inlet 41a is located so that it does not interface with the hot air passage inlet 12a in a view along the airflow direction Y perpendicular to a face 7a, 7b of the heater core 7. Further, the inlet 41a is located across the inlet 12a from the air mixing chamber 14. Therefore, uneven and excessive airflow to the rear outlet passage 41 is prevented.

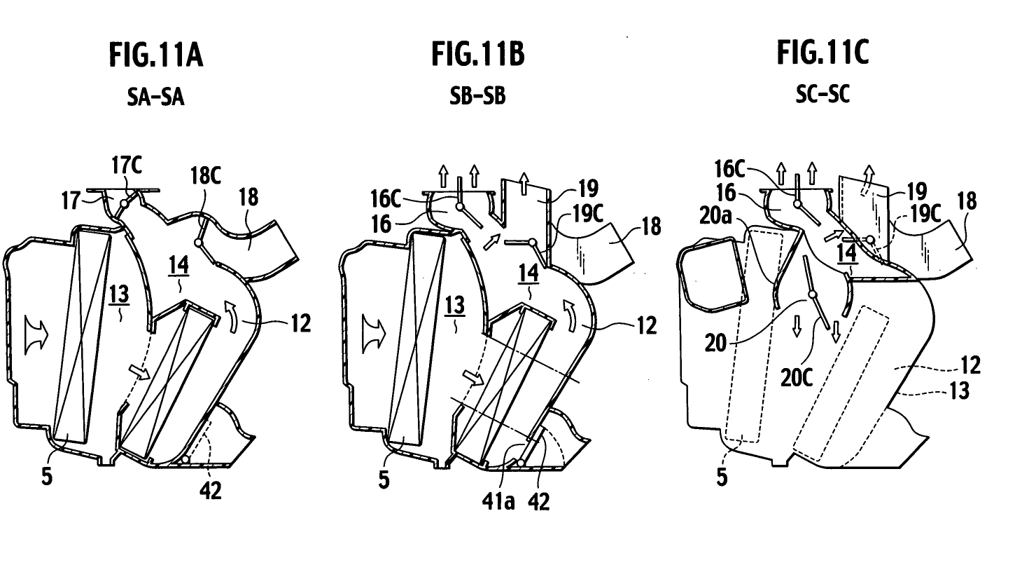

Defroster-Foot Mode (FIGS. 11A to 11C)

With reference to FIGS. 11A to 11C, the defroster-foot mode will be described. Specifically, in the defroster-foot mode, conditioned air is discharged from the defroster outlet passages 16 and the foot outlet passages 20. The opening of the doors 16C to 20C and 42 is adjusted so that the upper vent outlet passage 17 is totally closed and the center vent outlet passage 18 is totally closed as shown in FIG. 11A. The defroster outlet passages 16 are opened and the side vent outlet passages 19 are opened as shown in FIG. 11B; and the foot outlet passages 20 are opened as shown in FIG. 11C. In the defroster-foot mode, the air-conditioning mode is set to a full-heating mode. That is, the air mixing door 6 totally opens the hot air passage 12 and fully closes the bypass passage 13 so as to only discharge hot air.

With this arrangement, hot air flowing into the air mixing chamber 14 from the hot air passage 12 is discharged through the side-vent outlet passages 19, the defroster outlet passages 16 and the foot outlet passages 20 into the passenger compartment 55.

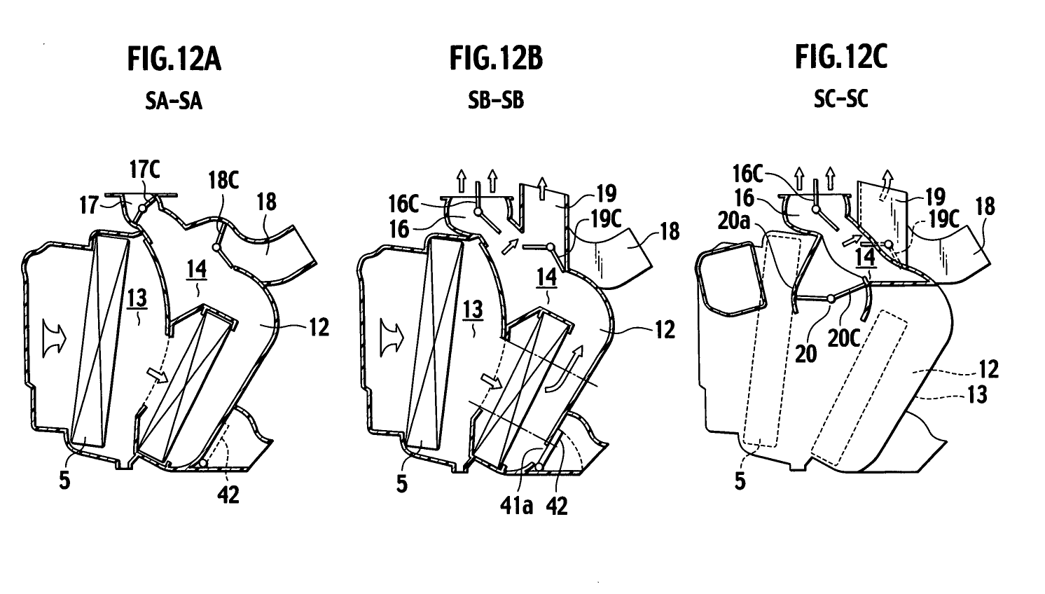

Defroster Mode (FIGS. 12A to 12C)

With reference to FIGS. 12A to 12C, a defroster mode will be described. In the defroster mode, conditioned air is discharged from the defroster outlet passages 16. Specifically, the opening of the doors 16C to 20C and 42 is adjusted so that the upper vent outlet passage 17 is totally closed and the center vent outlet passage 18 is totally closed as shown in FIG. 12A. The defroster outlet passages 16 are opened and the side vent outlet passages 19 are opened as shown in FIG. 12B; and, the foot outlet passages 20 are totally closed as shown in FIG. 12C. In the defroster mode, the air-conditioning mode is set to a full-heating mode. That is, the air mixing door 6 fully opens the hot air passage 12 and totally closes the bypass passage 13, so as to only discharge hot air.

With this arrangement, hot air flowing into the air mixing chamber 14, from the hot air passage 12, is discharged through the side vent outlet passages 19 and the defroster outlet passages 16 into the passenger compartment 55.

The structure and operation of the automotive air-conditioner in the first embodiment will be summarized below.

(I) According to the first embodiment, the rear outlet passage 41 is connected to the downstream portion 12b of the heater core 7 in the hot air passage 12. The air heated through the heater core 7 can directly flow into the rear outlet passage 41 without flowing through the air mixing chamber 14. Thus, the airflow resistance of the heated air flowing toward the rear seats is decreased.

According to the first embodiment, as shown in FIG. 5B, the inlet 41a of the rear outlet passage 41 does not overlap with the inlet 12a of the hot air passage 12 along an airflow direction Y. The inlet 41a is provided across the inlet 12a from the air mixing chamber 14 in the airflow direction Y. As a result, even when the rear outlet passage 41 is opened, excessive airflow to the rear outlet passage 41 is prevented.

(II) In the first embodiment, the bypass passage 13 is formed so as to be straight. A part of the hot air passage 12, that is, the downstream portion from the heater core 7, curves toward the bypass passage 13. Thus the bypass passages 13 and hot air passage 13 can be downsized while maintaining maximum performance in discharging cooled air. With this structure, the inlet 41a of the rear outlet passage 41 can be easily positioned near the rear face 7b of the heater core 7. Therefore, the structures described in the item (I), above, becomes more effective.

(III) In the first embodiment, the hot air guide wall 30 is disposed opposite and substantially parallel to the rear face 7b of the heater core 7. Thus, the automotive air-conditioner can be downsized in the airflow direction Y of the heater core 7. In the case of the first embodiment, for example, the airflow direction Y of the heater core 7 is in the vehicle's longitudinal direction. Therefore, the automotive air-conditioner can be made compact in the vehicle's longitudinal direction. With such structure, the inlet 41a of the rear outlet passage 41 is easily positioned near the rear face 7b of the heater core 7 so that the structures described in item (I), above, become more effective.

(IV) According to the first embodiment, the path 7A for high-temperature upstream flow is positioned in the side of the air mixing chamber 14; and the path 7B for low-temperature downstream flow is positioned in the side of the rear outlet passage inlet 41a. This structure positively avoids the problem where the temperature of the heated air flowing into the rear outlet passage 41 becomes too high. This structure has the front outlet passages as the major components and the rear outlet passages as the secondary components. In the first embodiment, the heater core 7 has two paths, however, three or more paths may be provided. In this case, an upstream path for hot water is located in the side of the air mixing chamber 14 and a downstream path is located in the side of the rear outlet passage inlet 41a so that the same effect is achieved.

### Second Embodiment

It is noted that, in the second embodiment, the same reference numbers will be used for the same or similar structures described in the first embodiment and the explanations for those structures or operations are omitted.

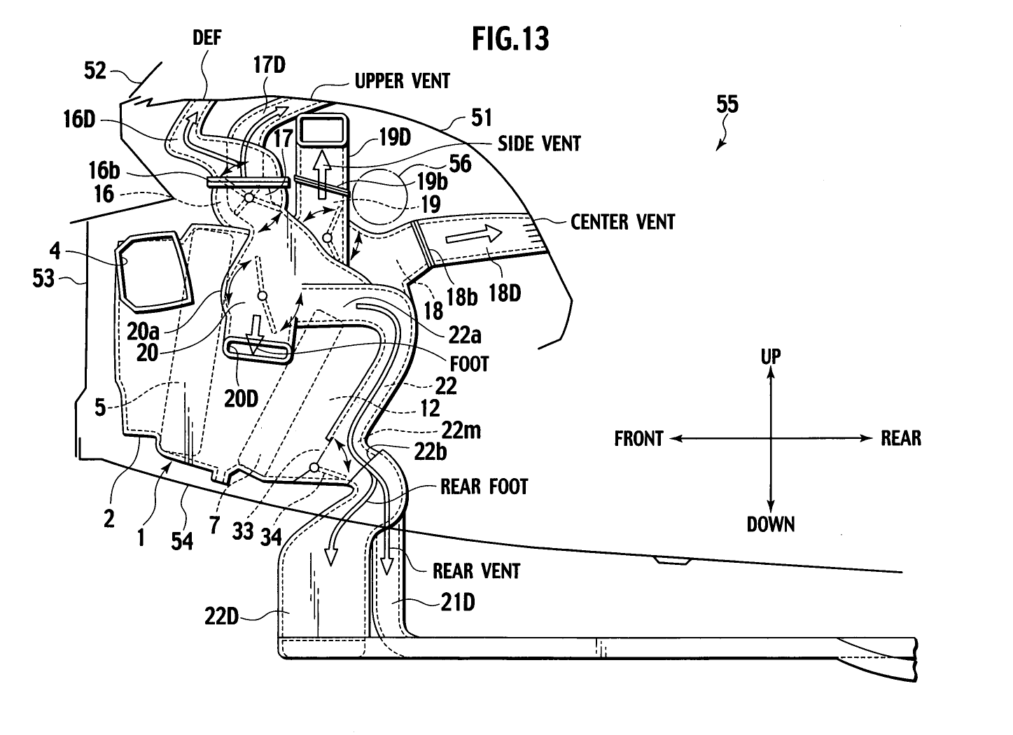

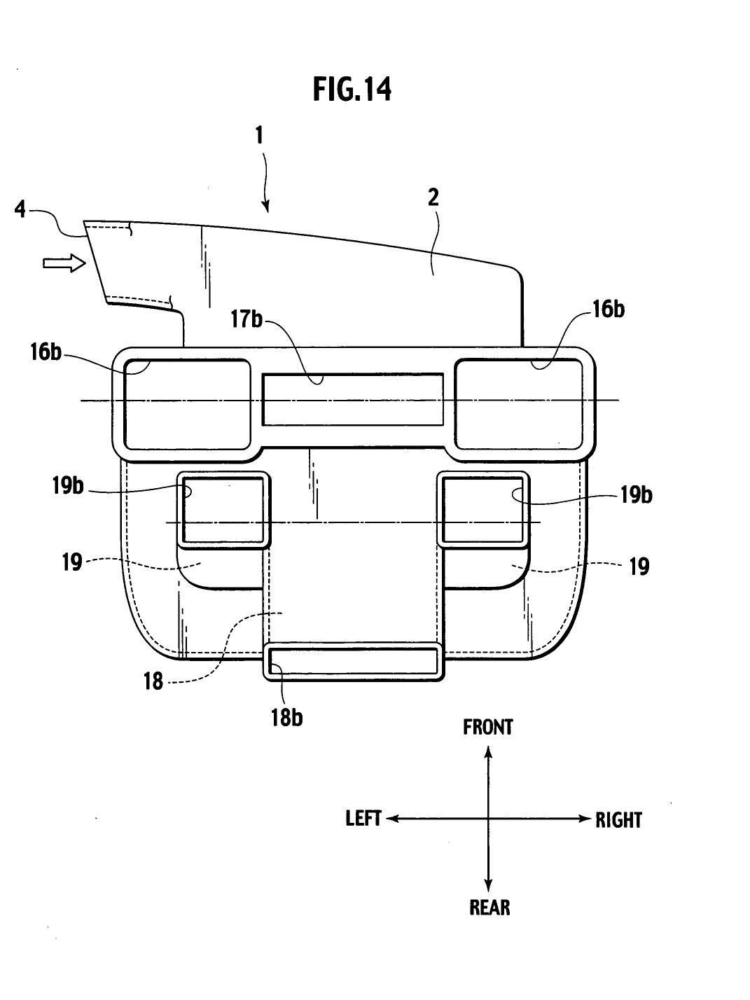

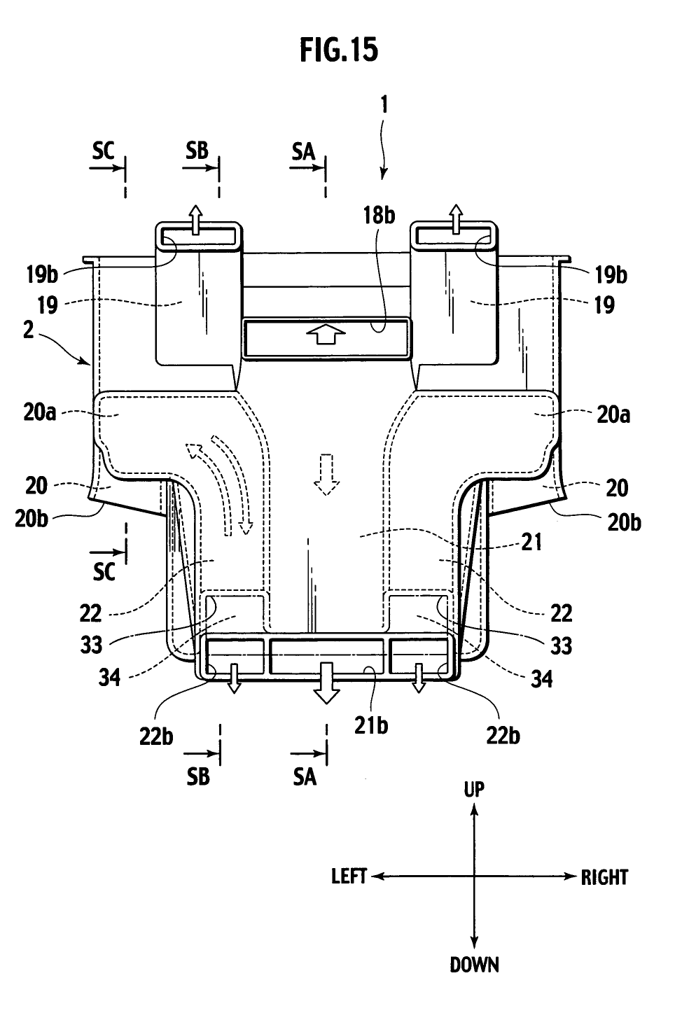

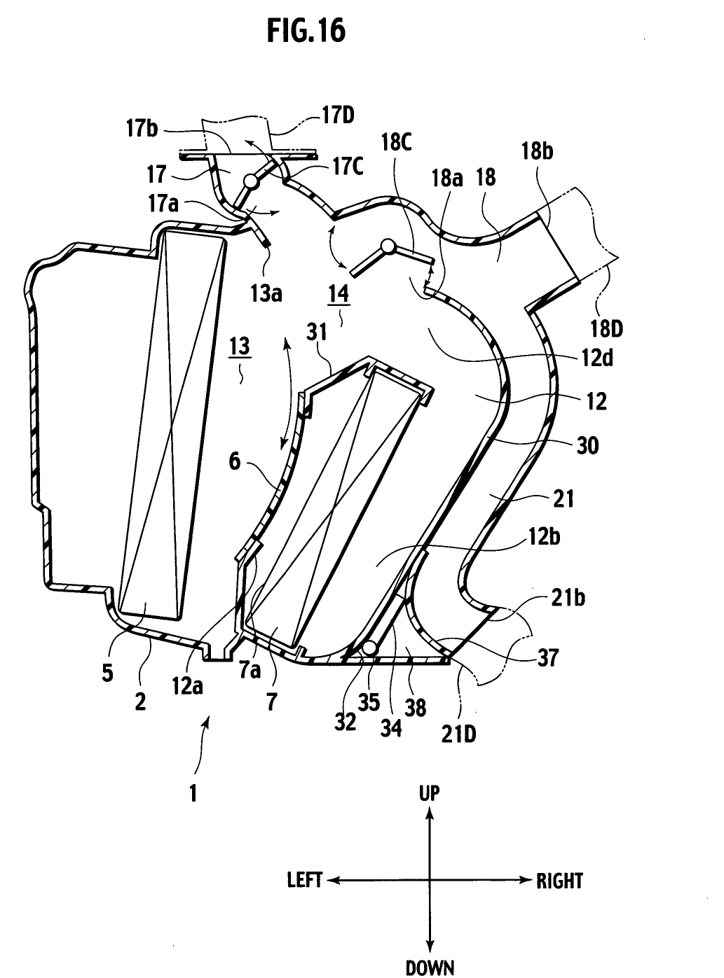

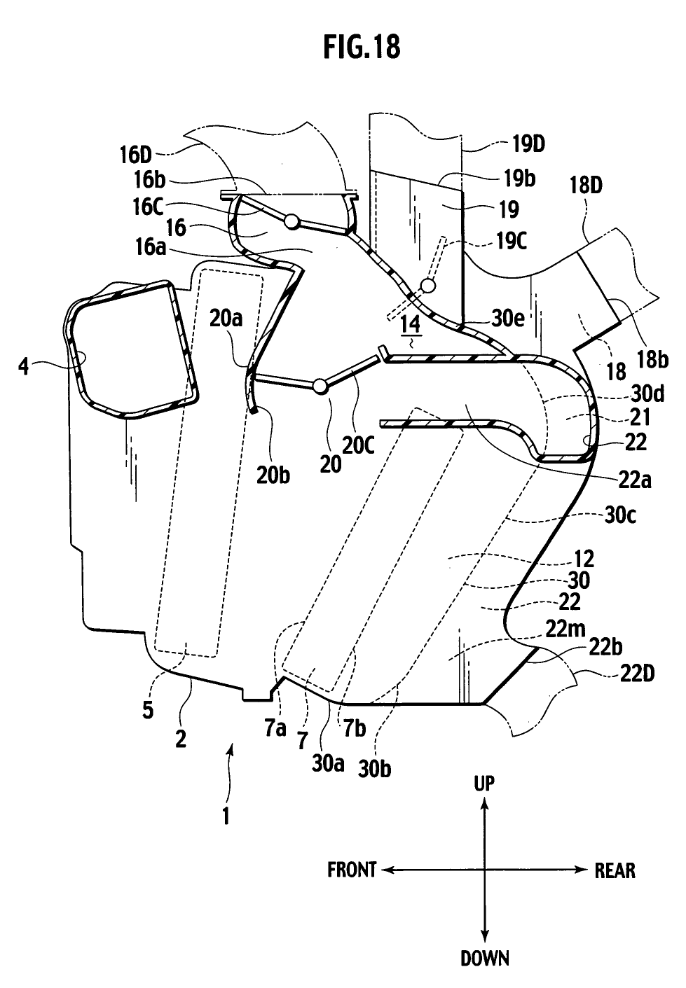

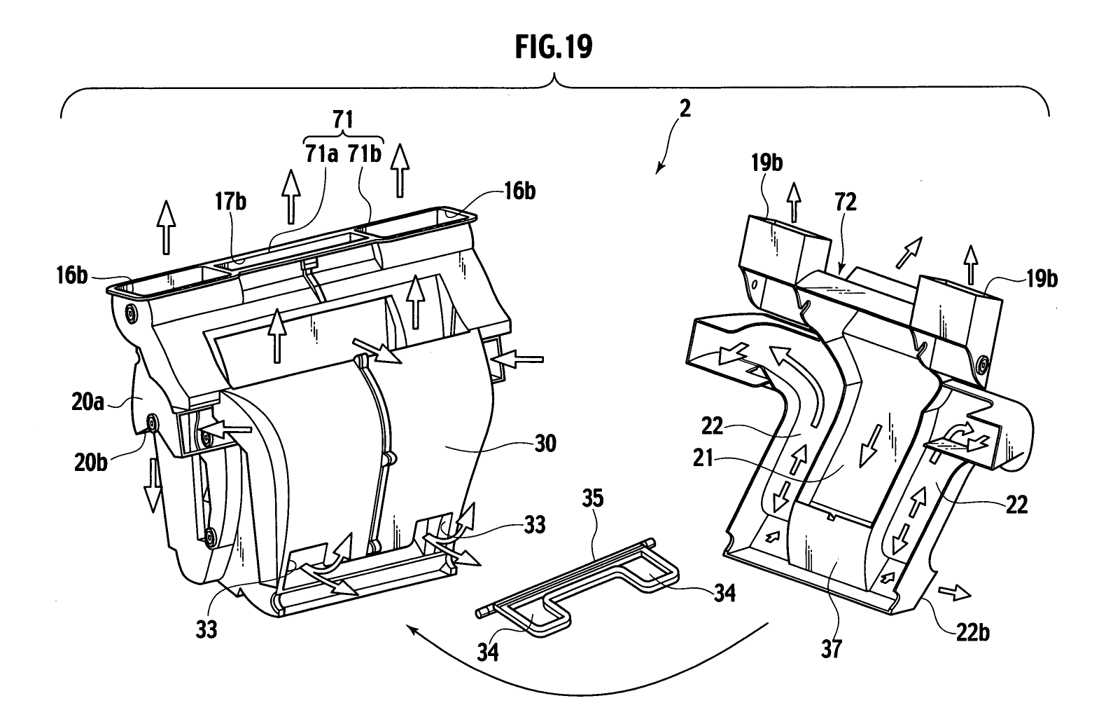

FIGS. 13 to 24C illustrate the second embodiment of the present invention.

An automotive air-conditioner of the second embodiment has rear outlet passages 21, 22 diverging from an air mixing chamber 14, in addition to a plurality of front outlet passages 16 to 20. This is a major difference, compared to the first embodiment. The second embodiment will be described focusing on the differences from the first embodiment.

More specifically, a rear vent outlet passage 21 diverges from a front center vent outlet passage 18, which is located in a downstream portion of the air mixing chamber 14. Rear foot outlet passages 22 diverge from inlets 20a of front foot outlet passages 20, which are located in the downstream portion of the air mixing chamber 14. A door 18C allows the rear vent outlet passage 21 to be opened and closed, together with the front center vent outlet passage 18. Doors 20C allow the rear foot outlet passages 22 to be opened and closed, together with the front foot outlet passage 20. Each of the doors 20C allows the foot outlet passages 20, 22 to be totally closed simultaneously, allows one to be opened while another is closed, or allows the foot outlet passages 20, 22 to be opened simultaneously.

The rear vent outlet passage 21 and rear foot outlet passages 22 are provided behind a hot air passage 12. The rear vent outlet passage 21 and rear foot outlet passages 22 are separated from the hot air passage 12 only by the hot air guide wall 30. The rear foot outlet passages 22 are provided on the right and left sides of the rear vent outlet passage 21.

Communication paths 33, which communicate the hot air passage 12 with the middle portions 22M of both rear foot outlet passages 22, are provided at the circular curving portion 30b in a lower portion of the hot air guide wall 30. Doors 34 are provided at the communication paths 33 for opening and closing the communication paths 33. The doors 34 of both communication paths 33 are integrally formed on a rotary shaft 35. Depending on opening and closing positions of the doors 34, all the hot air flowing through the communication paths 33 into the middle portions 22M of the rear foot outlet passages 22 can be directed to upstream portions 22a of the rear foot outlet passages 22; or the hot air can be distributed to the upstream portions 22a and the downstream portions 22b of the rear foot outlet passages 22. The communication paths 33 are opened toward the downstream portions 22b of the rear foot outlet passages 22. When totally opened, the doors 34 of the communication paths 33 face toward the downstream portions 22b of the rear foot outlet passages 22. When the doors 34 of the communication paths 33 are totally opened, almost all of the inflow hot air flows directly to the downstream portions 22b of the rear foot outlet passages 22.

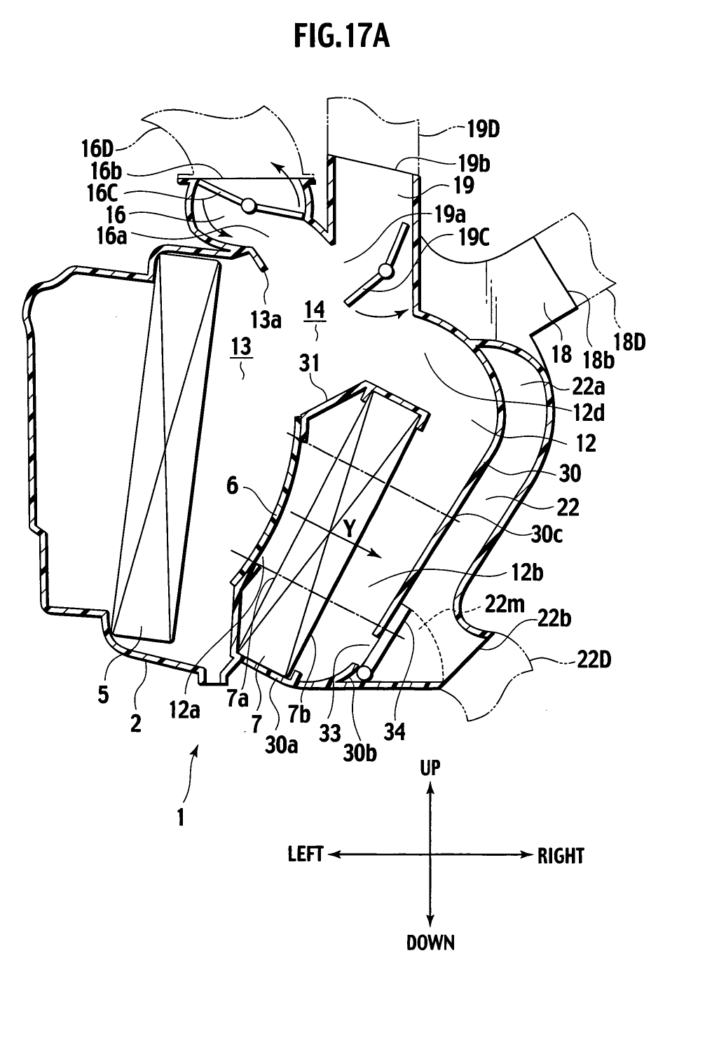

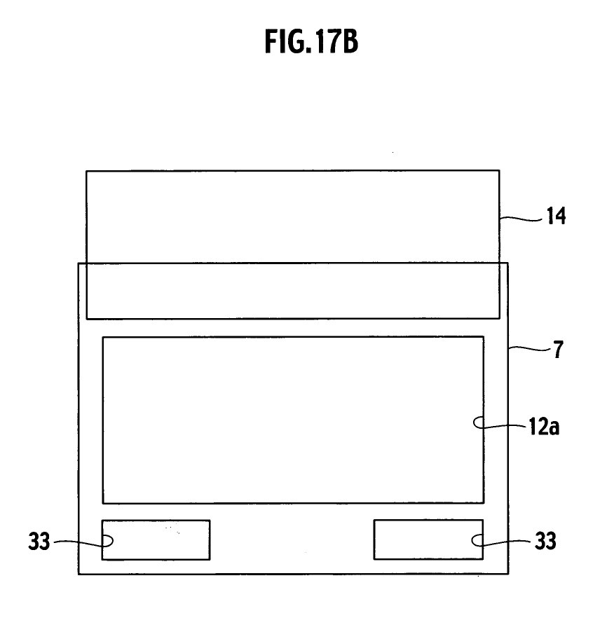

As shown in FIG. 17B, in the projected plane view along the airflow direction Y perpendicular to the faces 7a, 7b of the heater core 7, the communication paths 33 are located on a projected plane of the rear face 7b of the heater core 7. The communication paths 33 do not overlap with the inlet 12a of the hot air passage 12 in a view along the airflow direction Y. The communication paths 33 are located across the inlet 12a of the hot air passage 12 from the air mixing chamber 14 in the airflow direction Y.

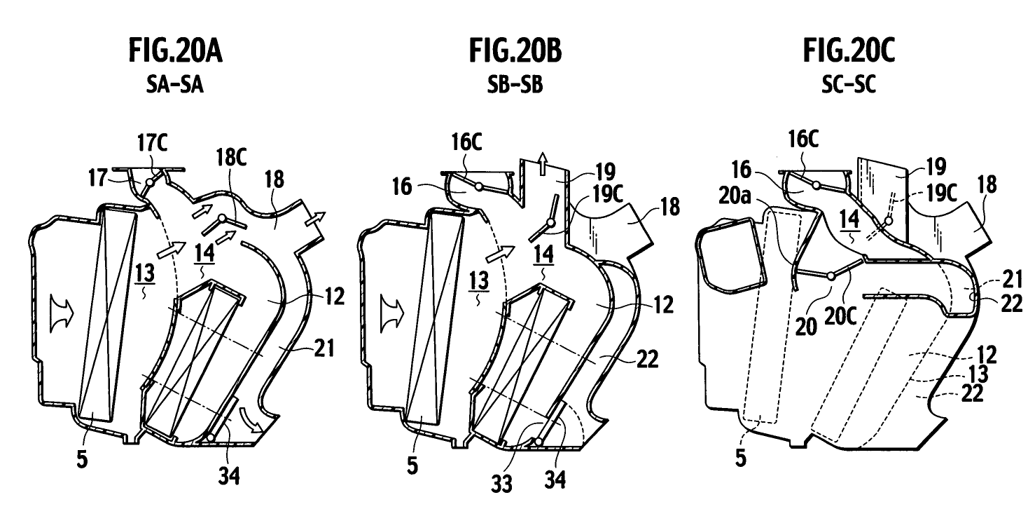

The flow of conditioned air in principal modes in the automotive air-conditioner configured as described above will be described with reference to FIGS. 20A to 24C.

Vent Mode (FIGS. 20A to 20C)

First, with reference to FIGS. 20A to 20C, a vent mode will be described in the vent mode, conditioned air is discharged from the vent outlet passages 18, 19 and 21. Specifically, the opening of the doors 16C to 20C and 34 is adjusted so that the upper vent outlet passage 17 is totally closed and the center vent outlet passage 18 is totally opened as shown in FIG. 20A. The defroster outlet passages 16 are totally closed and the side vent outlet passages 19 are totally opened as shown in FIG. 20B; and the foot outlet passages 20 and the rear foot outlet passages 22 are totally closed as shown in FIG. 20C. In the vent mode, the air-conditioning mode is set to a full-cooling mode. That is, the air mixing door 6 totally closes the hot air passage 12 and totally opens the bypass passage 13 so as to only discharge cooled air.

With this arrangement, cooled air flowing into the air mixing chamber 14 through the bypass passage 13 is discharged into the passenger compartment 55 through the center vent outlet passage 18, the side vent outlet passages 19, and the rear vent outlet passages 21.

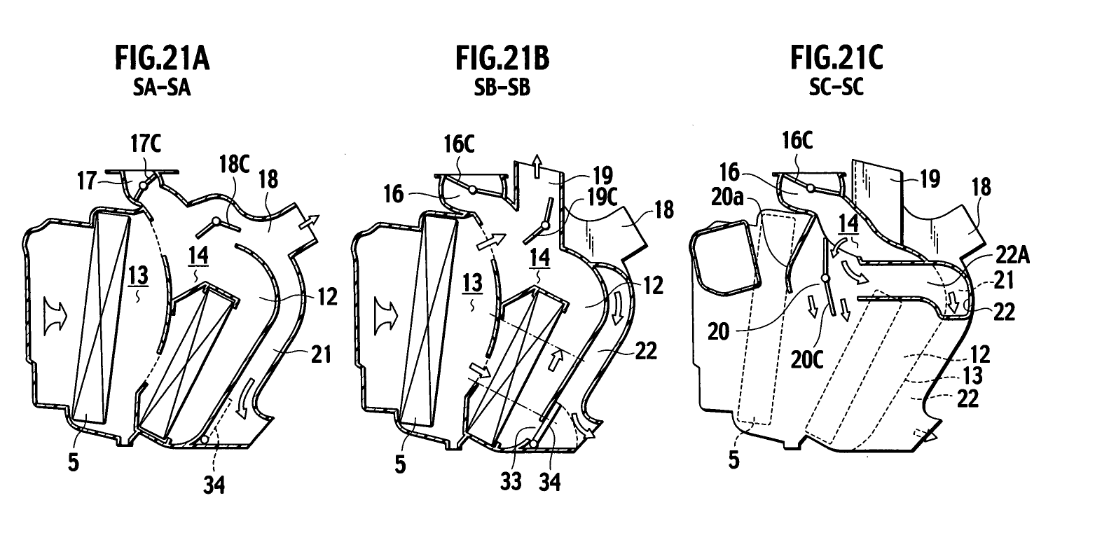

Bi-Level Mode (FIGS. 21A to 21C)

With reference to FIGS. 21A to 21C, a bi-level mode will be described. In the bi-level mode, conditioned air is discharged from both the vent outlet passages 18, 19 and the foot outlet passages 20. Specifically, the opening of the doors 16C to 20C and 34 is adjusted so that the upper vent outlet passage 17 is totally closed and the center vent outlet passage 18 is totally opened as shown in FIG. 21A; the defroster outlet passages 16 are totally closed and the side vent outlet passages 19 are totally opened as shown in FIG. 21B; and the foot outlet passages 20 and the rear foot outlet passages 22 are opened as shown in FIG. 21C. In the bi-level mode, the air-conditioning mode is set to an air-mixing mode. That is, the air mixing door 6 opens both the hot air passage 12 and the bypass passage 13 so that cooled air and heated air are mixed in the air mixing chamber 14 to discharge conditioned air.

With this arrangement, air mixed in the air mixing chamber 14 and conditioned to a desired temperature is discharged from the air mixing chamber 14 through the center vent outlet passage 18, the side vent outlet passages 19 and the rear vent outlet passages 21 into the passenger compartment 55. Also, the air is discharged through the foot outlet passages 20 and the rear foot outlet passages 22 into the passenger compartment 55.

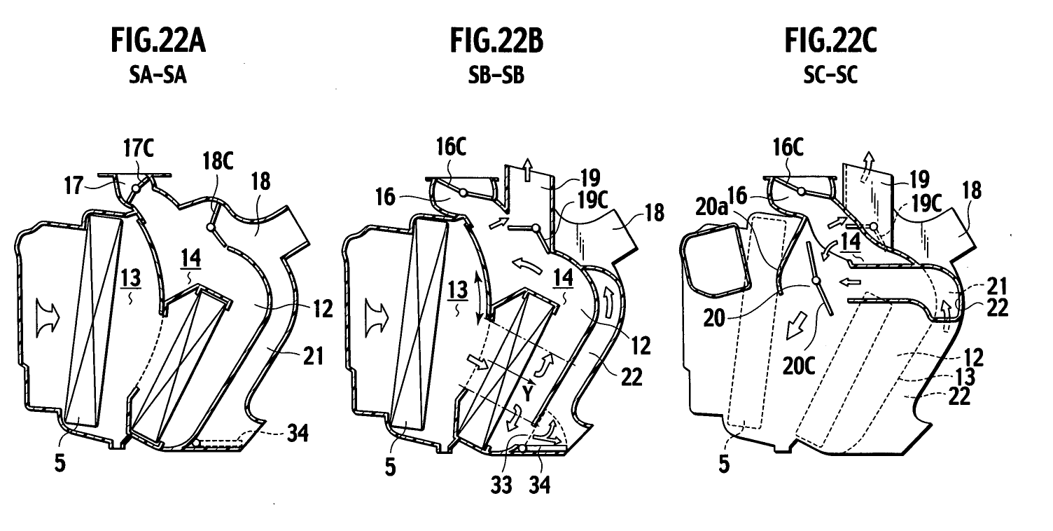

Foot Mode (FIGS. 22A to 22C)

With reference to FIGS. 22A to 22C, a foot mode will be described. In the foot mode, conditioned air is discharged from the foot outlet passages 20. Specifically, the opening of the doors 16C to 20C and 34 is adjusted so that the upper vent outlet passage 17 is totally closed and the center vent outlet passage 18 is totally closed as shown in FIG. 22A. The defroster outlet passages 16 are totally closed and the side vent outlet passages 19 are opened as shown in FIG. 22B; and, the foot outlet passages 20 and the rear foot outlet passages 22 are opened as shown in FIG. 22C. In the foot mode, the air-conditioning mode is set to a full-heating mode. That is, the air mixing door 6 totally opens the hot air passage 12 and totally closes the bypass passage 13 so as to only discharge hot air.

With this arrangement, as shown in FIG. 22B, some of the heated air flowing into the hot air passage 12 flows into the air mixing chamber 14 directly through the hot air passage 12, and the rest of the hot air flows into the middle portions 22m of the rear foot outlet passages 22 through the communication paths 33.

The hot air flowing into the air mixing chamber 14 through the hot air passage 12 (see FIG. 22B) is then discharged through the side vent outlet passages 19 and the foot outlet passages 20 into the passenger compartment 55 as shown in FIG. 22C.

The hot air flowing through the communication paths 33 into the middle portions 22m of the rear foot outlet passages 22 is divided into a flow to the upstream portions 22a and a flow to the downstream portions 22b in the rear foot outlet passages 22, as shown in FIG. 22B. The hot air flowing into the downstream portions 22b of the rear foot outlet passages 22 is directly discharged from a location below the seats of the vehicle into the passenger compartment 55. The hot air flowing into the upstream portions 22a of the rear foot outlet passages 22 is discharged from the inlets 20a of the foot outlet passages 20 through the foot outlet passages 20 toward the feet of the front seat occupants as shown in FIG. 22C. Depending on the opening and closing position of the doors 34, all the hot air flowing through the communication paths 33 can be directed to the upstream portions 22a of the rear foot outlet passages 22. In the second embodiment, when the doors 34 are positioned in the middle position between the open and closed positions, the downstream portions 22b of the rear foot outlet passages 22 is totally closed to direct all the hot air to the upstream portions 22a of the rear foot outlet passages 22.

The hot air flowing through the heater core 7 contacts the hot air guide wall 30 so that the hot air is divided into a flow directed to the air mixing chamber 14 and a flow directed to the communication path 33. Accordingly, there may be a concern that most of the hot air heated by the heater core 7 unequally flows into the rear foot outlet passages 22 because the communication paths 33 are located near the rear face 7b of the heater core 7. However, in the second embodiment, the communication paths 33 are positioned so as not to interface with the hot air passage inlet 12a. Further, the communication paths 33 are located across the inlet 12a from the air mixing chamber 14. Therefore, excessive airflow to the rear foot outlet passages 22 is prevented.

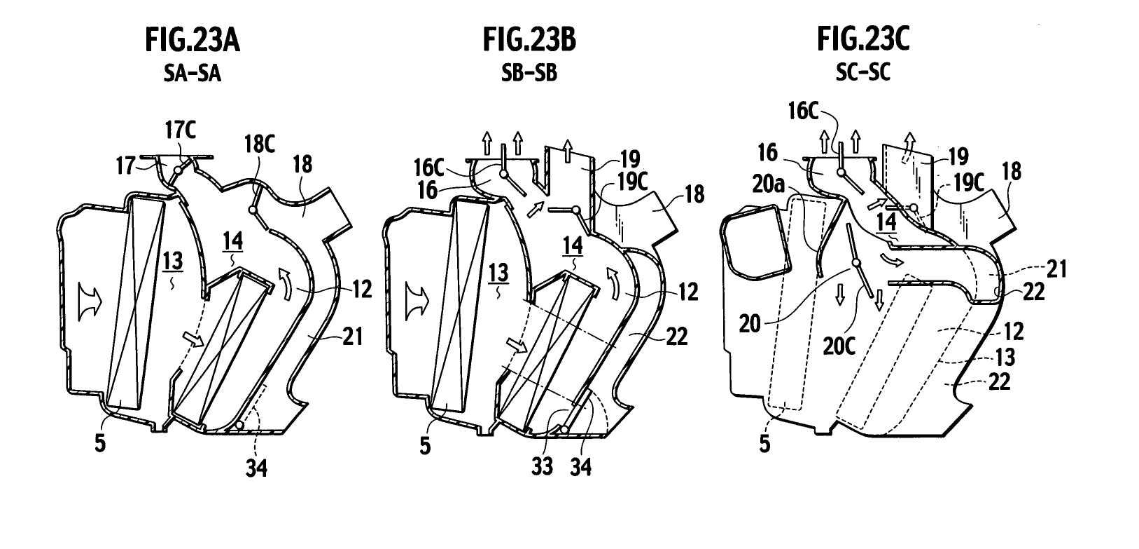

Defroster-Foot Mode (FIGS. 23A to 23C)

With reference to FIGS. 23A to 23C, the defroster-foot mode will be described. Specifically, in the defroster-foot mode, conditioned air is discharged from the defroster outlet passages 16 and the foot outlet passages 20. The opening of the doors 16C to 20C and 34 is adjusted so that the upper vent outlet passage 17 is totally closed and the center vent outlet passage 18 is totally closed as shown in FIG. 23A. The defroster outlet passages 16 are opened and the side vent outlet passages 19 are opened as shown in FIG. 23B; and, the foot outlet passages 20 and the rear foot outlet passages 22 are opened as shown in FIG. 23C. In the defroster-foot mode, the air-conditioning mode is set to a full-heating mode. That is, the-air mixing door 6 totally opens the hot air passage 12 and totally closes the bypass passage 13 so as to only discharge hot air.

With this arrangement, hot air flowing into the air mixing chamber 14 from the hot air passage 12 is discharged through the side vent outlet passages 19 and the defroster outlet passages 16 into the passenger compartment 55. Also, the hot air is discharged through the foot outlet passages 20 and the rear foot outlet passages 22 into the passenger compartment 55.

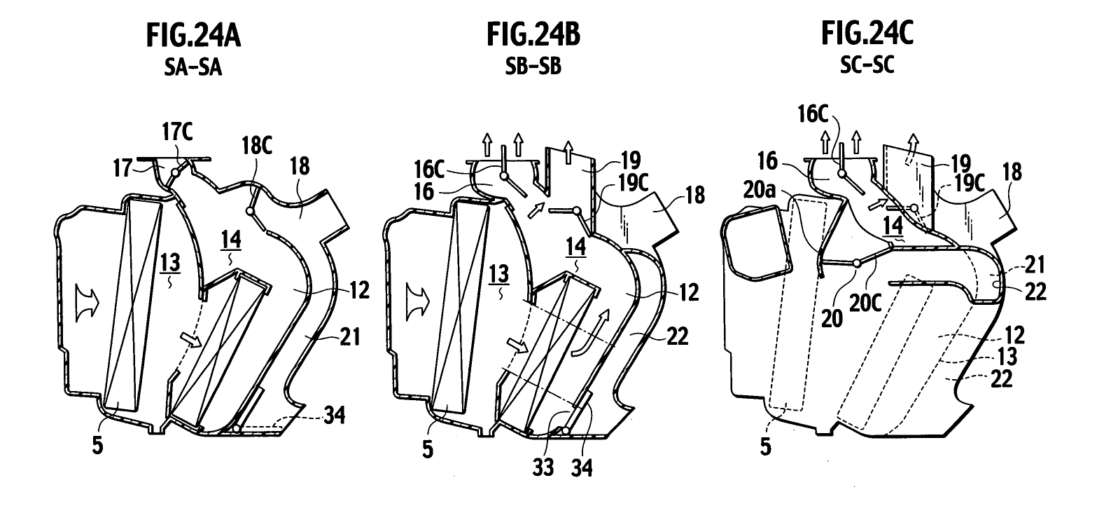

Defroster Mode (FIGS. 24A to 24C)

With reference to FIGS. 24A to 24C, a defroster mode will be described. In the defroster mode, conditioned air is discharged from the defroster outlet passages 16. Specifically, the opening of the doors 16C to 20C and 34 is adjusted so that the upper vent outlet passage 17 is totally closed and the center vent outlet passage 18 is totally closed as shown in FIG. 24A. The defroster outlet passages 16 are opened and the side vent outlet passages 19 are opened as shown in FIG. 24B; and, the foot outlet passages 20 and the rear foot outlet passages 22 are totally closed as shown in FIG. 24C. In the defroster mode, the air-conditioning mode is set to a full-heating mode. That is, the air mixing door 6 fully opens the hot air passage 12 and totally closes the bypass passage 13, so as to only discharge hot air.

With this arrangement, hot air flowing into the air mixing chamber 14 from the hot air passage 12 is discharged through the side vent outlet passages 19 and the defroster outlet passages 16 into the passenger compartment 55.

The structure and operation of the automotive air-conditioner in the second embodiment will be explained below.

(I) According to the second embodiment, same as in the first embodiment, the communication paths 33, which are connected to the middle portion 22m of the rear outlet passages 22, is provided to the downstream portion of the heater core 7 in the hot air passage 12. As a result, the hot air flowing in the hot air passage 12 can directly flow into the rear outlet passages 22 without flowing a long way through the air mixing chamber 14. Thus, the hot air flows to the rear seat with reduced airflow resistance.

According to the second embodiment, in the airflow direction Y perpendicular to a face 7a, 7b of the heating heat exchanger 7, the communication paths 33 are located across the inlet 12a of the hot air passage 12 from the air mixing chamber 14, and do not interfere with the inlet 12a of the hot air passage 12. As a result, even when the communication paths 33 are opened, excessive hot airflow to the rear outlet passages 22 is prevented.

(II) According to the second embodiment, the bypass passage 13 is formed to be straight and a part of the hot air passage 12, which is lower than the heater core 7, is curved toward the bypass passage 13. As a result, the bypass passages 13 and hot air passage 12 can be downsized maintaining maximum performance in discharging cooled air. With this structure, the communication paths 33 communicating with the rear outlet passages 22 can easily be provided near the rear face 7b of the heater core 7. Therefore, the structures described in (I) above, become more effective.

(III) According to the second embodiment, the hot air guide wall 30 is disposed opposite and substantially parallel to the rear face 7b of the heater core 7. As a result, the automotive air-conditioner is downsized in the airflow direction Y in the heater core 7. In the case of the second embodiment, for example, the airflow direction Y in the heater core 7 is the vehicle's longitudinal direction. Therefore, the automotive air-conditioner can be made compact in the vehicle's longitudinal direction. With such structure, the communication paths 33 are easily provided near the rear face 7b of the heater core 7 so that the structures described in (I) above, become more effective.

(IV) According to the second embodiment, the path 7A for high-temperature upstream flow is positioned in the side of the air mixing chamber 14; and the path 7B for low-temperature downstream flow is positioned in the side of the communication paths 33. This structure positively avoids temperature of the heated air flowing into the rear outlet passages 22 excessive.

(V) According to the automotive air-conditioner of the second embodiment, rear foot outlet passages 22 are provided along the hot air passage 12 so that air flowing from the air mixing chamber 14 into the rear foot outlet passages 22 flows in the opposite direction from the direction of airflow in the hot air passage 12. The communication paths 33, which communicate with the rear foot outlet passages 22 and have doors 34, are provided in an upstream portion of the hot air passage 12. When the communication paths 33 are opened by adjusting the doors 34, at lease a part of the air flowing into the rear foot outlet passages 22 from the communication paths 33 can flow in the direction of the upstream portion of the rear foot outlet passages 22. Thus, as shown in FIGS. 22A to 22C, when the communication paths 33 are opened, a part of the hot air from the heater core 7 is led to the air mixing chamber 14 through the hot air passage 12 and the rear foot outlet passages 22. Accordingly, the hot air flow space 12, 22 from the heater core 7 to the air mixing chamber 14 is widened. At the same time, airflow resistance to hot air flow from the heater core 7 to the air mixing chamber 14 is reduced.

(VI) According to the automotive air-conditioner of the second embodiment, distributing doors are provided for distributing hot air flowing from the communication paths 33 into the rear foot outlet passages 22 in the direction of the upstream portion 22a of the rear foot outlet passages 22 and the downstream portion 22b of the rear foot outlet passages 22. (Here, in the second embodiment, the doors 34 also operate as distributing doors.)

(VII) According to the automotive air-conditioner of the second embodiment, the structure can be simplified as the doors 34 of the communication paths 33 operate as distributing doors (34). As a result, the automotive air-conditioner is compact and the production cost is reduced.

(VIII) According to the automotive air-conditioner of the second embodiment, the hot air guide wall 30 for guiding the hot air from the heater core 7 in the direction of the bypass passage 13 separates the hot air passage 12 and the rear foot outlet passages 22. Accordingly, there is no wasted space between the hot air passage 12 and the rear foot outlet passages 22. Therefore, the automotive air-conditioner can be compact. As the second embodiment is an example in which the hot air passage 12 and the rear foot outlet passages 22 are arranged in a line in the vehicle's longitudinal direction, the automotive air-conditioner is compact in the vehicle's longitudinal direction.

(IX) To make the hot air passage 12 compact, the hot air passage 12 is highly curved and the hot air guide wall 30 is located close to and facing to the rear face 7b of the heater core 7. With this structure, the reverse flow through passage 22 is more effective at reducing airflow resistance.

Although the invention has been described above by reference to certain embodiments of the invention, the invention is not limited to the embodiments described above. Modification and variation of the embodiments can be made without departing from the sprit or scope of the appended claims. Therefore, the embodiments are only for illustrative purpose and do not limit the invention.

What is claimed is:

1. An automotive air-conditioner, comprising:
a heating heat exchanger;
a bypass passage through which cool air bypasses the heating heat exchanger;
a hot air passage through which hot air passing through the heating heat exchanger flows, the hot air passage including a downstream portion of the heating heat exchanger curved toward the bypass passage;
an air mixing door configured to control airflow volume of cool air flowing through the bypass passage and hot air flowing through the hot air passage;
an air mixing chamber located at a confluence of the bypass passage and the hot air passage and configured to mix the hot air and the cool air;
at least one front outlet passage diverging from the air mixing chamber toward a front side of a passenger compartment;
a rear outlet passage diverging from downstream of the heating heat exchanger in the hot air passage toward a rear side of the passenger compartment;
a door configured to open and close the rear outlet passages; and
an inlet of the rear outlet passage configured to avoid overlap with an inlet of the hot air passage in an airflow direction perpendicular to a face of the heating heat exchanger, the inlet of the rear outlet passage being provided across the inlet of the hot air passage from the air mixing chamber in the airflow direction.

2. An automotive air-conditioner as set forth in claim 1, further comprising a hot air guide wall configured to guide hot air flown from the heating heat exchanger to the bypass passage, the hot air guide wall provided at a downstream portion of the heating heat exchanger, the hot air guide wall being substantially parallel to a rear face of the heating heat exchanger.

3. An automotive air-conditioner as set forth in claim 1,
wherein the heating heat exchanger includes a plurality of paths through which a heating medium flows,
an upstream path of the plurality of paths being located in a side of the air mixing chamber,
a downstream path of the plurality of paths being located in a side of the inlet of the rear outlet passage.

4. An automotive air-conditioner, comprising:
a heating heat exchanger;
a bypass passage through which cool air bypasses the heating heat exchanger;
a hot air passage through which hot air passing through the heating heat exchanger flows, the hot air passage including a downstream portion of the heating heat exchanger curved toward the bypass passage;
an air mixing door configured to control airflow volume of cool air flowing through the bypass passage and hot air flowing through the hot air passage;
an air mixing chamber located at a confluence of the bypass passage and the hot air passage and configured to mix the hot air and the cool air;
at least one front outlet passage diverging from the air mixing chamber toward a front side of a passenger compartment;
at least one rear outlet passage diverging from the air mixing chamber toward a rear side of the passenger compartment;
a communication path diverging from downstream of the heating heat exchanger in the hot air passage to at least one of the at least one rear outlet passage, the communication path configured to avoid overlap with an inlet of the hot air passage in an airflow direction perpendicular to a face of the heating heat exchanger, the communication path provided across the inlet of the hot air passage from the air mixing chamber in the airflow direction; and
a door configured to open and close the communication path.

5. An automotive air-conditioner as set forth in claim 4, further comprising a hot air guide wall configured to guide hot air from the heating heat exchanger to the bypass passage, the hot air guide wall provided downstream of the heating heat exchanger, the hot air guide wall being substantially parallel to a rear face of the heating heat exchanger.

6. An automotive air-conditioner as set forth in claim 4,
wherein the heating heat exchanger includes a plurality of paths through which a heating medium flows,
an upstream path of the paths being located in a side of the air mixing chamber,
a downstream path of the paths being located in a side of the communication path.
